(19) United States
(12) Patent Application Publication
(10) Pub. No.: US 2014/0211519 A1
(43) Pub. Date: Jul. 31, 2014

(54) SINGLE-STAGE PFC CONVERTER WITH CONSTANT VOLTAGE AND CONSTANT CURRENT

(71) Applicant: SYSTEM GENERAL CORPORATION, New Taipei City (TW)

(72) Inventors: Jhih-Da HSU, New Taipei City (TW); Li LIN, Taipei City (TW)

(73) Assignee: SYSTEM GENERAL CORPORATION, New Taipei City (TW)

(21) Appl. No.: 14/231,955

(22) Filed: Apr. 1, 2014

Related U.S. Application Data
(63) Continuation-in-part of application No. 13/182,291, filed on Jul. 13, 2011, now Pat. No. 8,711,583.
(60) Provisional application No. 61/429,640, filed on Jan. 4, 2011.

(51) Int. Cl. H02M 1/42

(52) U.S. Cl. CPC H02M 1/4258
USPC 363/21.17

(57) ABSTRACT

An exemplary embodiment of a switching controller for a power converter is provided. The switching controller for a power converter comprises: a power device, an input circuit and a compensation capacitor. The power device is coupled to switch a transformer of the power converter for regulating an output voltage and an output current of the power converter. The input circuit is coupled to the transformer to sample an input signal which is correlated to the output voltage of the power converter to obtain a feedback signal. The feedback signal is utilized to generate a switching signal for controlling the power device. The switching signal is modulated to operate the power converter in boundary current mode (BCM) or discontinuous current mode (DCM).

### CROSS REFERENCE TO RELATED APPLICATIONS

The present application is a continuation-in-part application of and claims priority to U.S. patent application Ser. No. 13/182,291, filed Jul. 13 2011, which claimed priority to U.S. Provisional Application No. 61/429,640, filed on Jan. 4, 2011. The contents of these prior applications are hereby incorporated by reference in their entireties.

### BACKGROUND OF THE INVENTION

1. Field of the Invention

The invention relates to a single stage power factor correction (PFC) converter, and more particularly to a single stage PFC converter with constant voltage and constant current output for power supply, battery charger and LED lighting driver, etc.

2. Description of the Related Art

FIG. 1 shows a prior art of an offline power converter. The offline power converter comprises a transformer 10, a power transistor 20, a resistor 30, an input bridge-rectifier 35, a diode 41, a high input electrolytic capacitor 43, a capacitor 45, a switching controller 100, resistors 51 and 52, a diode 60, and a capacitor 65. The transformer 10 includes a primary winding N_{P}, an auxiliary winding N_{A,} and a secondary winding N_{S}. The high input electrolytic capacitor 43 is used for the energy storage. Waveforms of an input line voltage V_{AC}, an input line current I_{AC}, and an input voltage V_{IN} in FIG. 1 are shown in FIG. 2. The input voltage V_{IN} is the voltage on the high input electrolytic capacitor 43. The high capacitance input capacitor 43 will cause distortion of the input line current I_{AC} and generate poor power factor (PF). Therefore, the capacitance of the high input electrolytic capacitor 43 must be reduced to improve the power factor. However, having no input capacitor with high capacitance will produce a low input voltage V_{IN}. The low voltage of the input voltage V_{IN} will cause feedback open loop for the offline power converter. An output voltage V_{O} of the offline power converter can be expressed as,

$${V}_{O} = N \times {V}_{IN} \times \frac{{T}_{ON}}{T - {T}_{ON}} \qquad ( 1 )$$

where N represents a turn ratio of the transformer 10 (N=N_{S}/N_{P}; N_{P} is the primary winding, and N_{S} is the secondary winding); V_{IN} represents the input voltage of the transformer 10 (also the voltage on the high input electrolytic capacitor 43); T_{ON} represents on-time of a switching signal S_{W} which controls the power transistor 20; T represents a switching period of the power transistor 20.

In order to achieve a stable feedback loop and prevent transformer saturation, the maximum duty cycle “T_{ON}/T” is limited, such as <80% in general. If the input voltage V_{IN} is too low, the maximum on-time T_{ON} of the switching signal S_{W} will be unable to maintain the regulated output voltage V_{O} (shown in equation (1)) and cause the feedback open loop. When the feedback loop is significantly on/off (close-loop and open-loop) in response to the change of the input line voltage V_{AC}, an overshoot and/or undershoot signal can be easily generated at the output of the power converter. Besides, the input capacitor 43 is an electrolytic capacitor that is bulky and has low reliability. The object of this invention is to improve the power factor of the power converter without the need of extra power factor correction (PFC) power stage. Another object of this invention includes eliminating the need of the input electrolytic capacitor for improving the reliability of the power converter and reducing the size and the cost of the power converter.

### BRIEF SUMMARY OF THE INVENTION

An exemplary embodiment of a switching controller for a power converter is provided. The switching controller for a power converter comprises: a power device, an input circuit, and a compensation capacitor. The power device is coupled to switch a transformer of the power converter for regulating an output voltage and an output current of the power converter. The input circuit is coupled to the transformer to sample an input signal which is correlated to the output voltage of the power converter to obtain a feedback signal. The feedback signal is utilized to generate a switching signal for controlling the power device. The switching signal is modulated to operate the power converter in boundary current mode (BCM) or discontinuous current mode (DCM). The compensation capacitor provides frequency compensation for a feedback loop of the power converter. A bandwidth of the frequency compensation is lower than two times of a line frequency of the power converter to achieve approximately fixed on-time of the switching signal. An input capacitor connected to an input of the power converter is small enough to guarantee an input voltage having a full-wave rectified waveform to be received by the transformer. The output voltage of the power converter is approximately constant when the output current of the power converter is lower than its maximum value. The switching controller further comprises an integrator for controlling the output current of the power converter as a constant. The switching controller further comprises an error amplifier for developing the feedback loop of the power converter. The error amplifier is a multi-vector error amplifier. An output of the error amplifier is coupled to the compensation capacitor. An input bridge rectifier rectifies an AC line input voltage of the power converter with the line frequency into the input voltage having two times of the line frequency. A high-speed diode is coupled between the input bridge rectifier and the transformer. A reverse recovery time of the high-speed diodes is lower than 500 nsec. The input capacitor is an electrolytic capacitor less than 1 uF. The input capacitor can also be a ceramic capacitor.

Another exemplary embodiment of a switching controller for a power converter is provided. The switching controller for a power converter comprises: an input circuit and a compensation capacitor. The input circuit coupled to a transformer for generating a switching signal in response to a current control loop of the power converter. The switching signal is modulated to operate the power converter in boundary current mode (BCM) or discontinuous current mode (DCM). The compensation capacitor provides frequency compensation for the current control loop of the power converter. A bandwidth of the frequency compensation is lower than two times of a line frequency of the power converter to achieve approximately fixed on-time of the switching signal. An input capacitor connected to an input of the power converter is small enough to guarantee an input voltage having a full-wave rectified waveform to be received by the transformer.

The object of this invention is to improve a power factor of a power converter without a requirement of an extra PFC power stage.

Another object of this invention includes elimination of a requirement of a input electrolytic capacitor for improving the reliability of the power converter and reducing the size and the cost of the power converter.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows a prior art of an offline power converter;

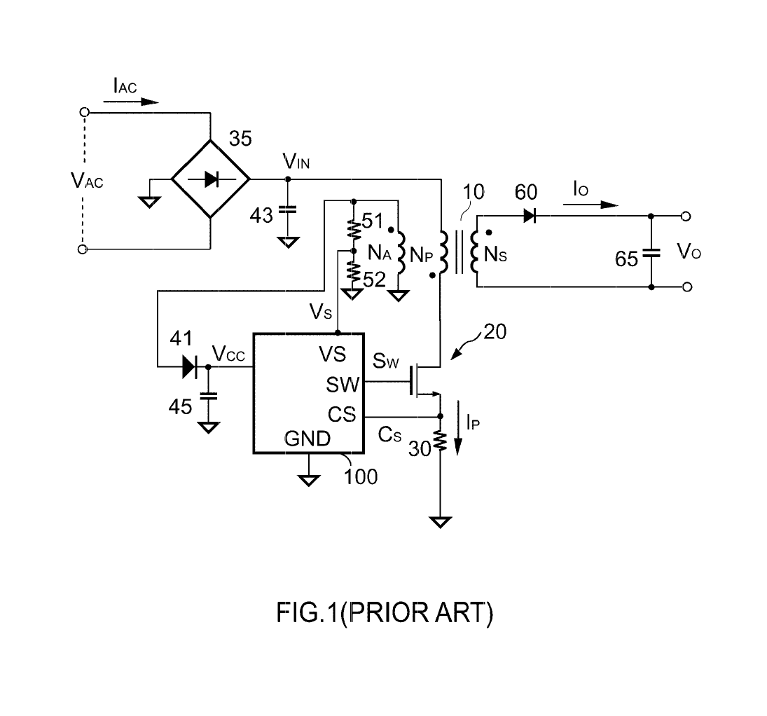

FIG. 2 shows waveforms of an input line voltage V_{AC}, an input line current I_{AC}, and an input voltage V_{IN} of FIG. 1;

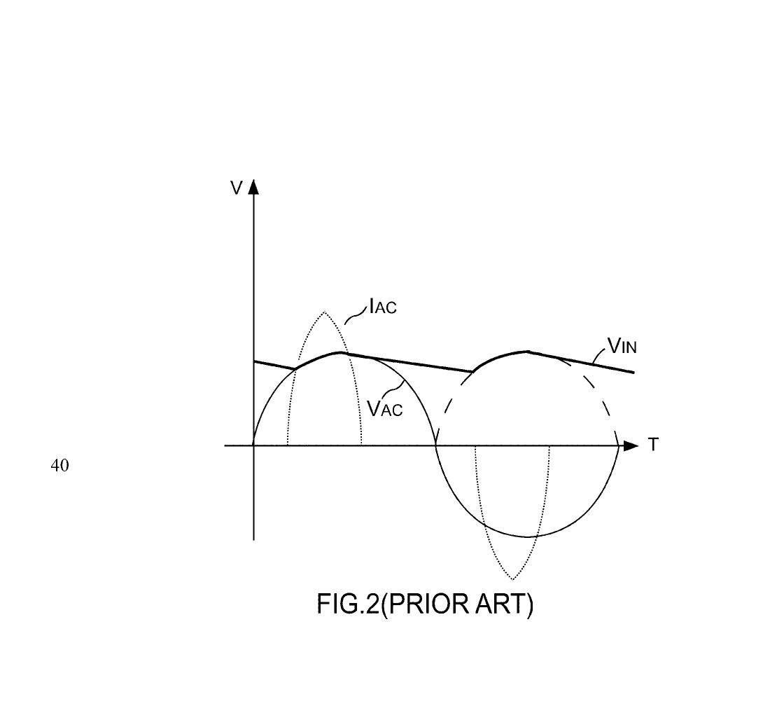

FIG. 3 is an exemplary embodiment of a power converter;

FIG. 4 is another exemplary embodiment of a power converter;

FIG. 5 shows the waveforms of the input line voltage V_{AC}, input line current I_{AC}, and the input voltage V_{IN} in the power converters of FIG. 3 and FIG. 4;

FIG. 6 is an exemplary embodiment of a switching controller in the power converters of FIG. 3 and FIG. 4;

FIG. 7 shows an exemplary embodiment of a PWM circuit in the switching controller of FIG. 6;

FIG. 8 shows an exemplary embodiment of a signal generation circuit in the PWM circuit of FIG. 7;

FIG. 9 shows a switching signal in the power converters of FIG. 3 and FIG. 4 when the switching signal is operated in BCM; and

FIG. 10 shows waveforms of an input voltage and an input current in the power converters of FIG. 3 and FIG. 4 when switching signal is operated in BCM.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The present invention provides a single stage power factor correction (PFC) converter with a constant voltage and a constant current output for power supply circuit, battery charger and LED lighting driver, etc. The single stage PFC converter provides a high power factor (PF). In an embodiment, the single stage PFC power converter can be an offline or no-isolated power converter. Flyback power conversion with primary side regulation is used for the output voltage and the output current regulation.

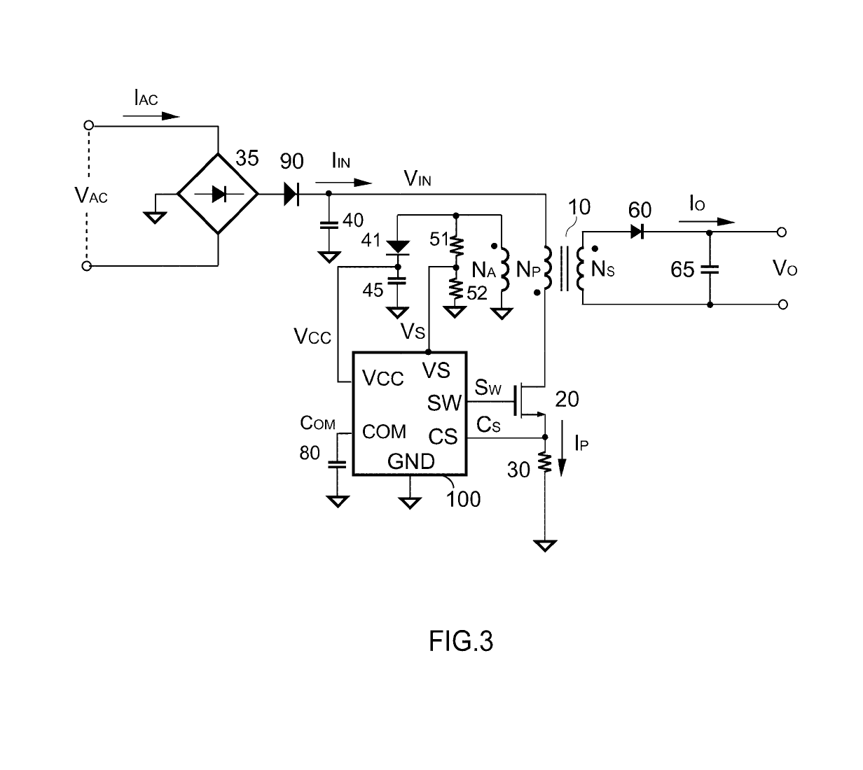

FIG. 3 is an exemplary embodiment of a power converter. The power converter is implemented based on the primary-side controlled power converter. The detail description of the primary-side controlled power converter can be found in the prior arts of an U.S. Pat. No. 6,977,824 titled “Control circuit for controlling output current at the primary side of a power converter”, an U.S. Pat. No. 7,016,204 titled “Close-loop PWM controller for primary-side controlled power converters”, an U.S. Pat. No. 7,349,229 titled “Causal sampling circuit for measuring reflected voltage and demagnetizing time of transformer”, and U.S. Pat. No. 7,486,528 titled “Linear-predict sampling for measuring demagnetized voltage of transformer”. For a multi-vector error amplifier, the related prior arts include U.S. Pat. No. 6,900,623 titled “Power supply having multi-vector error amplifier for power factor correction”. Referring to the power factor correction, the skill has been disclosed in the prior art of U.S. Pat. No. 7,116,090 titled “Switching control circuit for discontinuous mode PFC converters” and U.S. Pat. No. 6,952,354 titled “Single stage PFC power converter”.

A transformer 10 includes a primary winding N_{P}, an auxiliary winding N_{A}, and a secondary winding N_{S}. The primary winding Np is coupled to receive an input voltage V_{N}. Resistors 51 and 52 are connected to the auxiliary winding N_{A} for generating a voltage-sense signal V_{S} coupled to a switching controller 100. In the embodiment, the switching controller 100 is a primary-side controlled circuit. The switching controller 100 generates a switching signal S_{W} coupled to switch the transformer 10 through a power transistor 20 (power device), and accordingly, an output current I_{O} and an output voltage V_{O} (output signal) are generated through a diode 60 and a capacitor 65. When the power transistor 20 is turned on, a switching current I_{P} will flow through the transformer 10. Via a resistor 30, the switching current I_{P} further generates a current-sense signal C_{S} coupled to the switching controller 100. A capacitor 80 connected to a compensation terminal COM of the switching controller 100 provides a low-frequency-bandwidth frequency compensation for a feedback loop of the power converter. In order to achieve a high PF value, the low-frequency-bandwidth of the feedback loop is required to be lower than two times of the line frequency (<100/120 Hz). Furthermore, this low bandwidth feedback loop determined by the capacitor 80 also prevents the output of the power converter from being unstable when the input voltage V_{N} is lower than the threshold that shown in equation (1).

A diode 41 and a capacitor 45 are coupled to the auxiliary winding N_{A} to generate a power source V_{CC} for the switching controller 100. Input of an input bridge-rectifier 35 is coupled to a line input of the power converter for receiving an AC input line voltage V_{AC} with a line frequency and the input line current I_{AC}. An input capacitor 40 is coupled to an output of the input bridge-rectifier 35. The line bridge rectifier 35 receives the AC input line voltage V_{AC} to generate the input voltage V_{N}, which has a full-wave rectified waveform, across the capacitor 40. In other words, the frequency of the input voltage V_{N} is two times of the line frequency of the AC input line voltage V_{AC}. Generally, based on a criterion to accomplish the present invention, the capacitor 40 must be small enough to let the input voltage V_{N} having full-wave rectified waveform to be received by the transformer 10. The capacitor 40 can be an electrolytic capacitor with capacitance less than 1 uF or a ceramic capacitor. Since the capacitance of the capacitor 40 is small, the capacitor 40 is utilized to achieve better EMI, not for smoothing the full-wave rectified waveform of the input voltage V_{N} as a direct-current voltage. The input bridge-rectifier 35 is normally formed by high-voltage and low-speed rectifiers. The switching frequency of the power converter is >20 kHz in general. A high-speed diode 90, e.g. its reverse-recovery time T_{RR} is <500 nsec, is coupled between the input bridge-rectifier 35 and the capacitor 40. The high-speed diode 90 is utilized to prevent a reverse switching current of the transformer 10 from being output to the line input of the power converter, and therefore achieve a better PF value and EMI.

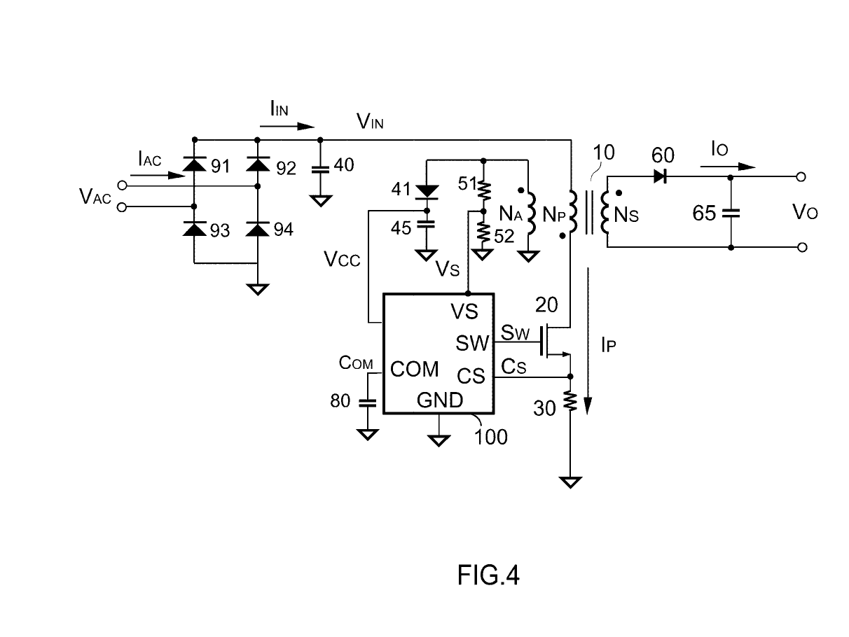

FIG. 4 is another exemplary embodiment of a power converter. In FIGS. 3 and 4, the same reference signs represent the same elements, and thus, the description about the same elements is omitted here. The difference between the embodiments of FIGS. 3 and 4 is that the power converter in the embodiment of FIG. 4 comprises high-speed diodes 91, 92, 93, and 94 in place of the input bridge-rectifier 35 in the embodiment of FIG. 3.

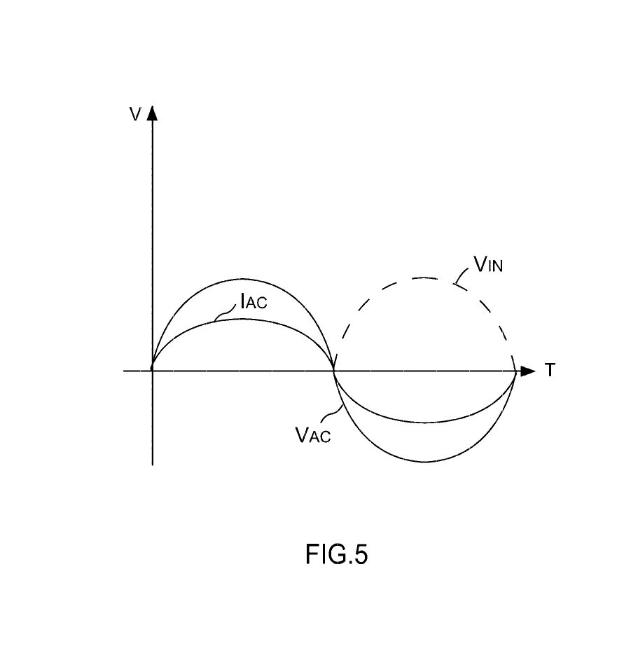

FIG. 5 shows the waveforms of the input line voltage V_{AC}, the input line current I_{AC}, and the input voltage V_{IN} having full-wave rectified waveform in the embodiments of FIG. 3 and FIG. 4. Referring to FIG. 5, the input line current I_{AC} follows the input line voltage V_{AC}, which achieves a good PF value and low THD (total harmonic distortion).

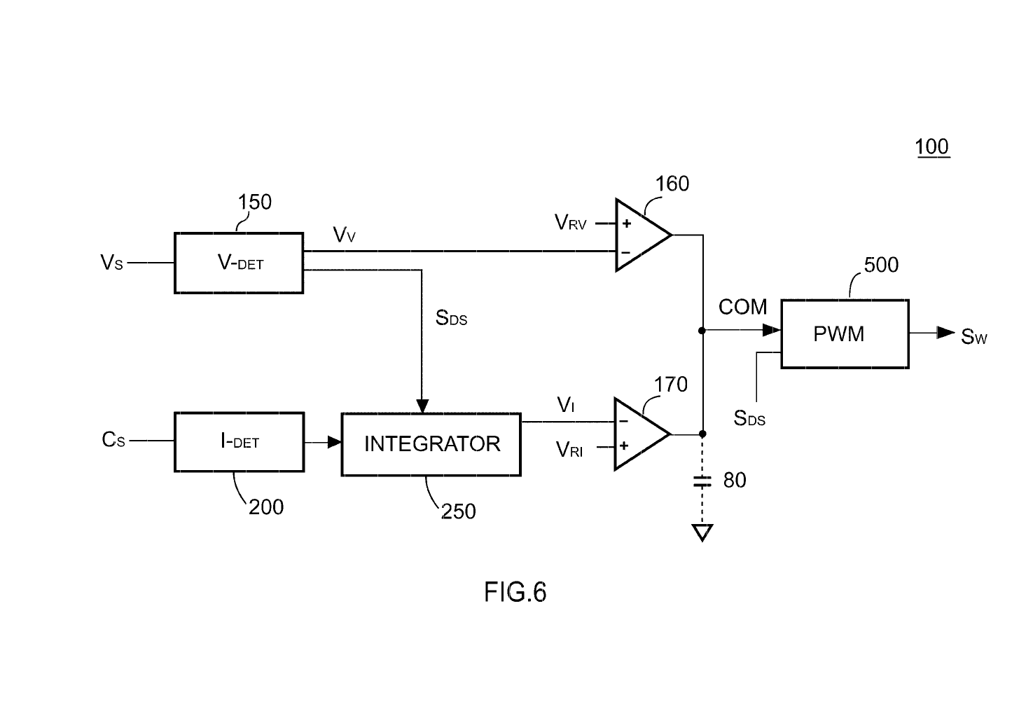

FIG. 6 is an exemplary embodiment of the switching controller 100. An input circuit of the switching controller 100 is coupled to the transformer 10 to sample the voltage-sense signal V_{S} and the current-sense signal C_{S} which represent an input signal collectively. The input circuit comprises a voltage-detection circuit (V-_{DET}) 150 and a current-detection circuit (I-_{DET}) 200. The voltage-detection circuit 150 is connected to the voltage-sense signal V_{S} to generate a voltage-feedback signal V_{V} and a demagnetizing-time signal S_{DS}. The voltage-feedback signal V_{V} is coupled to an error amplifier 160 to compare with a reference signal V_{RV}. The current-detection circuit 200 is coupled to receive the current-sense signal C_{S} to generate a current-feedback signal V_{I} through an integrator 250 in accordance with the current-sense signal C_{S} and the demagnetizing-time signal S_{DS}. The current-feedback signal V_{I} is further coupled to an error amplifier 170 to compare with a reference signal V_{RI}. Both the error amplifiers 160 and 170 are transconductance amplifiers or multi-vector error amplifiers for achieving better dynamic transit response. The output of the error amplifiers 160 and 170 are coupled to the capacitor 80 for generating a compensated signal C_{OM} coupled to a PWM circuit (PWM) 500 to generate the switching signal S_{W} according to the compensated signal C_{OM} and the demagnetizing-time signal S_{DS}. When the output current I_{O} of the power converter is higher than its maximum level, the output current I_{O} will be a constant current for driving a load (not shown). Thus, the switching signal S_{W} is controlled by the current-feedback signal V_{I} and the compensated signal C_{OM} to achieve a constant output current I_{O}. When the output current I_{O} of power converter is lower than its maximum level, the voltage-feedback signal V_{V} and the compensated signal C_{OM} will be utilized to regulate maximum output voltage V_{O}. As the described above, the input signal is correlated to the output of the power converter. Therefore, in order to achieve a high PF value, the compensated signal is developed to provide a “constant on-time” for the switching signal S_{W} during the period of line frequency. Thus, the bandwidth of the feedback loop should be lower than the line frequency. The line frequency is 50 or 60 Hz in general.

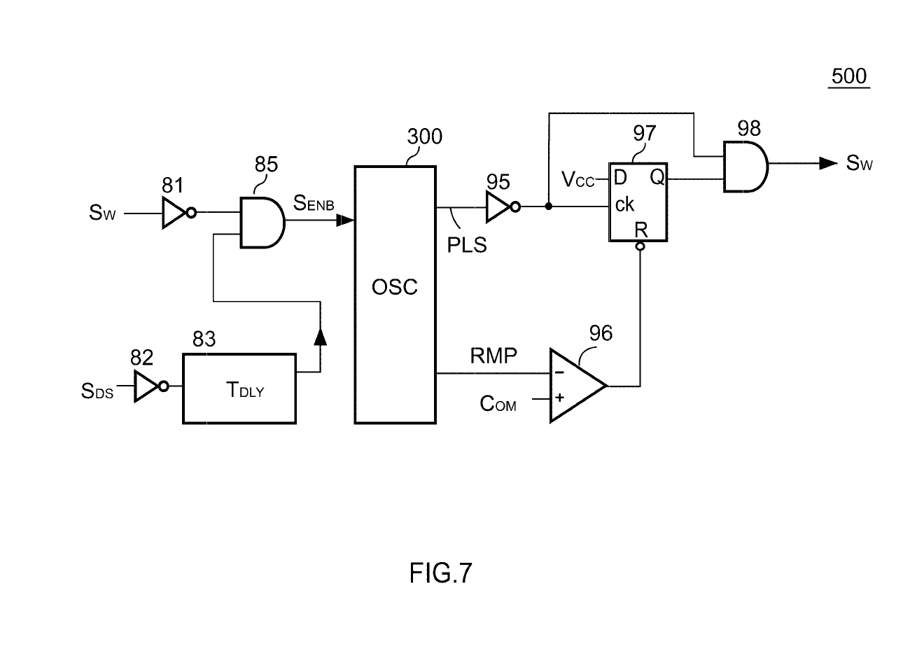

FIG. 7 is an exemplary embodiment of the PWM circuit 500. A signal generation circuit 300 generates a pulse signal PLS to turn on the switching signal S_{W} through an inverter 95, a flip-flop 97, and an AND gate 98. In the embodiment, the signal generation circuit 300 is an oscillator (OSC). The signal generation circuit 300 further generates a ramp signal RMP coupled to a comparator 96 to compare with the compensated signal C_{OM} for turning off the switching signal S_{W}. The signal generation circuit 300 generates the pulse signal PLS in response to an enable signal S_{ENB} to achieve a “boundary current mode (BCM) operation” or “discontinuous current mode (DCM) operation” (not shown) for the power conversion. The BCM operation will help to improve the PF. The enable signal S_{ENB} is generated according to the switching signal S_{W} and the demagnetizing-time signal S_{DS}. The demagnetizing-time signal S_{DS} is coupled to generate the enable signal S_{ENB} through an inverter 82, a delay circuit 83 and an AND gate 85. The switching signal S_{W} is coupled to generate the enable signal S_{ENB} through an inverter 81 and the AND gate 85. The enabling of the demagnetizing-time signal S_{DS} means that the transformer 10 is fully demagnetized.

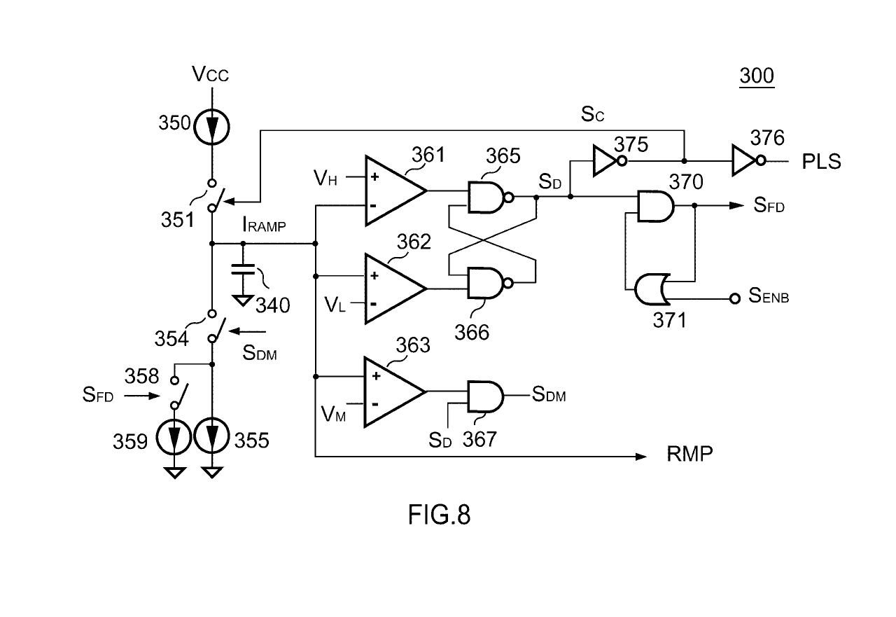

FIG. 8 shows an exemplary embodiment of the signal generation circuit 300. A current source 350 is coupled to charge a capacitor 340 through a switch 351. A current source 355 is coupled to discharge the capacitor 340 through a switch 354 due to the current of the current source 355. The switch 351 is controlled by a charge signal S_{c}. The switch 354 is controlled by a discharge signal S_{DM}. The capacitor 340 thus generates a ramp signal I_{RAMP} (that is the ramp signal RMP) coupled to comparators 361, 362 and 363. The comparator 361 has a threshold V_{H}. The comparator 362 has a threshold V_{L}. The comparator 363 has a threshold V_{M}, and the levels of the thresholds are V_{H}>Vₘ>V_{L}. NAND gates 365 and 366 form a latch circuit coupled to receive output signals of the comparators 361 and 362. The latch circuit outputs a discharge signal Sp. The discharge signal S_{D} is a maximum frequency signal. The discharge signal S_{D} and an output signal of the comparator 363 are connected to an AND gate 367 for generating the discharge signal S_{DM}.

The discharge signal S_{D} is also connected to an inverter 375 to generate the charge signal S_{c}. The charge signal S_{c} is connected to an inverter 376 to generate the pulse signal PLS. The pulse signal PLS is generated during the discharge period of the capacitor 340. The discharge signal S_{D} is further coupled to an input of an AND gate 370 to generate a fast-discharge signal S_{FD}. The fast-discharge signal S_{FD} and the enable signal S_{ENB} are connected to an OR gate 371. The output of the OR gate 371 is connected to another input of the AND gate 370. Therefore, the enable signal S_{ENB} will trigger the fast-discharge signal S_{FD} once the discharge signal S_{D} is enabled. The fast-discharge signal S_{FD} can be turned off only when the discharge signal S_{D} is disabled. A current source 359 is connected to the switch 358. The switch 358 is controlled by the fast-discharge signal S_{FD}. Since the current of the current source 359 is high, the capacitor 340 will be immediately discharged when the fast-discharge signal S_{FD} is enabled. During the discharge period, the ramp signal I_{RAMP} is hold at the level of the threshold V_{M} until the enable signal S_{ENB} starts the fast-discharge signal S_{FD}. Once the capacitor 340 is discharged lower than the threshold V_{L}, the discharge signal S_{D} will be disabled.

The demagnetizing-time signal S_{DS} is thus able to trigger the pulse signal PLS once the discharge signal S_{D} is enabled. Therefore, the switching control of the power conversion can be operated in a BCM. The current of the current source 350, the capacitance of the capacitor 340, and the thresholds V_{H}, V_{M}, and V_{L} determine the maximum frequency of the discharge signal S_{D} and determine the maximum frequency of the switching signal S_{W}.

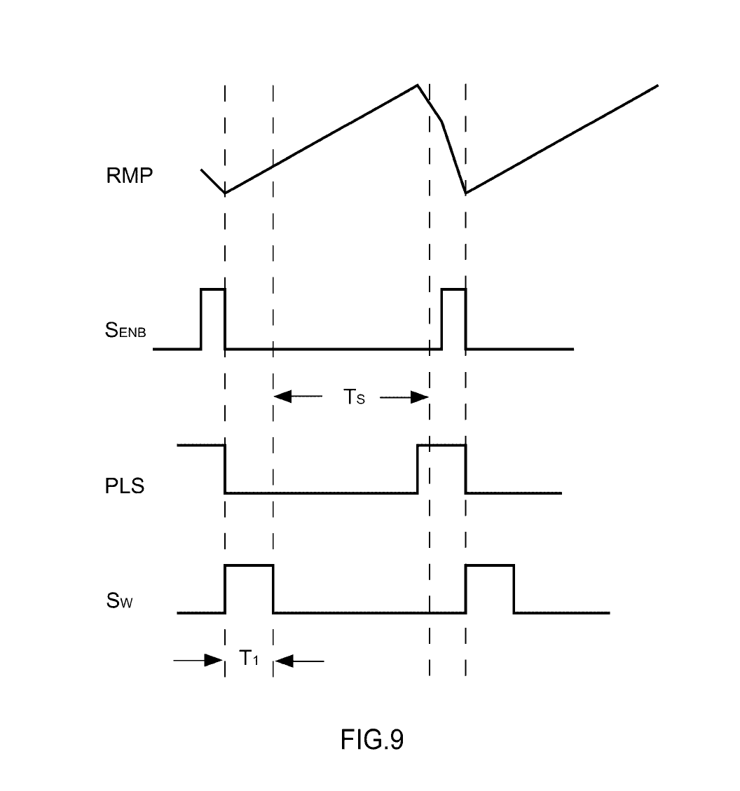

FIG. 9 shows the switching signal S_{W} operated at a BCM. The switching signal S_{W} is turned on during a period Tᵢ. The period T_{S} shows the demagnetizing time of the transformer 10. The demagnetizing time T_{S} is correlated to the demagnetizing-time signal S_{DS}. Further referring to FIG. 7 and FIG. 9, the ramp signal RMP and the compensated signal C_{OM} are compared to turn off the switching signal S_{W}. Since the bandwidth of the frequency compensation conducted by the compensated signal C_{OM} is very low, the fluctuation of the compensated signal C_{OM} is quite little and therefore the periods T₁ (on-time) of the switching signal S_{W} in each cycles are almost the same.

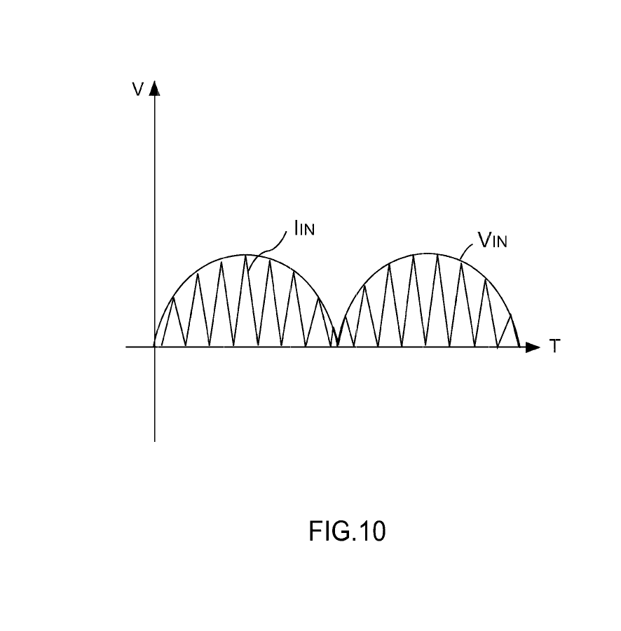

FIG. 10 shows the waveforms of the input voltage V_{IN} and an input current I_{N} when the switching signal S_{W} is operated at a BCM. Since each rising slope of the input current I_{N} is correlated to the full-wave rectified waveform of the input voltage V_{IN} applied to the transformer 10, the approximately fixed on-time of the switching signal S_{W} will force the input current I_{N} to naturally follow the full-wave rectified waveform of the input voltage V_{IN}. In addition, the switching signal S_{W} can also be operated in DCM since the same natural following operation as described above can be done once the input current I_{N} can be discharged to zero.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A switching controller for a power converter comprising:
a power device, coupled to switch a transformer of said power converter for regulating an output voltage and an output current of said power converter;
an input circuit, coupled to said transformer to sample an input signal which is correlated to said output voltage of said power converter to obtain a feedback signal, wherein said feedback signal is utilized to generate a switching signal for controlling said power device, and said switching signal is modulated to operate said power converter in boundary current mode (BCM) or discontinuous current mode (DCM); and
a compensation capacitor providing frequency compensation for a feedback loop of said power converter,
wherein a bandwidth of said frequency compensation is lower than two times of a line frequency of said power converter to achieve approximately fixed on-time of said switching signal, and
wherein an input capacitor connected to an input of said power converter is small enough to guarantee an input voltage having a full-wave rectified waveform to be received by said transformer.

2. The switching controller as claimed in claim 1, wherein said output voltage of said power converter is approximately constant when said output current of said power converter is lower than its maximum level.

3. The switching controller as claimed in claim 1 further comprises an integrator for controlling said output current of said power converter as a constant.

4. The switching controller as claimed in claim 3 further comprising an error amplifier for developing said feedback loop of said power converter, wherein said error amplifier is a multi-vector error amplifier, and an output of said error amplifier is coupled to said compensation capacitor.

5. The switching controller as claimed in claim 1, wherein an input bridge rectifier rectifies an AC line input voltage of said power converter with said line frequency into said input voltage having two times of said line frequency.

6. The switching controller as claimed in claim 5, wherein a high-speed diode is coupled between said input bridge rectifier and said transformer, and reverse recovery time of said high-speed diodes is lower than 500 nsec.

7. The switching controller as claimed in claim 1, wherein said input capacitor is an electrolytic capacitor less than 1 uF.

8. The switching controller as claimed in claim 1, wherein said input capacitor is a ceramic capacitor.

9. A switching controller for a power converter comprising:
an input circuit, coupled to a transformer for generating a switching signal in response to a current loop, wherein said switching signal is modulated to operate said power converter in boundary current mode (BCM) or discontinuous current mode (DCM); and
a compensation capacitor providing frequency compensation for said current loop of said power converter,
wherein a bandwidth of said frequency compensation is lower than two times of a line frequency of said power converter to achieve approximately fixed on-time of said switching signal, and
wherein an input capacitor connected to an input of said power converter is small enough to guarantee an input voltage having a full-wave rectified waveform to be received by said transformer.
